(19) United States
(12) Patent Application Publication
(10) Pub. No.: US 2026/0178401 A1
(43) Pub. Date: Jun. 25, 2026

(54) LATENCY UNDER LOAD TRACKING IN A MEMORY CONTROLLER

(71) Applicant: Rambus Inc., San Jose, CA (US)

(72) Inventors: Steven C. Woo, Saratoga, CA (US); J. James Tringali, Los Altos, CA (US)

(21) Appl. No.: 19/413,373

(22) Filed: Dec. 9, 2025

Related U.S. Application Data
(60) Provisional application No. 63/737,552, filed on Dec. 20, 2024.

(51) Int. Cl. G06F 9/50; G06F 11/34

(52) U.S. Cl. CPC G06F 9/5038; G06F 9/5044; G06F 11/3419

(57) ABSTRACT

A memory controller includes a processing device to execute latency tracking logic to determine respective latencies for a plurality of memory access requests in a memory access queue. The latency tracking logic further determines respective bandwidth usages of the memory controller corresponding to the plurality of memory access requests and stores respective counts of the plurality of memory access requests having respective latencies corresponding to a plurality of latency ranges for the respective bandwidth usages. The latency tracking logic further configures operations of the memory controller in view of the respective counts for the respective bandwidth usages.

### RELATED APPLICATIONS

This application claims the benefit of U.S. Provisional Patent Application No. 63/737,552 filed Dec. 20, 2024, the contents of which is incorporated by reference in its entirety herein.

### TECHNICAL FIELD

Aspects and embodiments of the disclosure relate to memory controllers, and more specifically, to systems and methods for latency under load tracking in a memory controller.

### BACKGROUND

A memory controller may manage the flow of data between a host system and memory components of a memory system. Each memory component may include either the same or a different type of media. Examples of media include, but are not limited to, volatile dynamic random access memory (DRAM) or static random access memory (SRAM), a cross-point array of non-volatile memory, and other non-volatile memory such as NAND-type flash based memory.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a memory controller includes a processing device to execute latency tracking logic to determine respective latencies for a plurality of memory access requests in a memory access queue, determine respective bandwidth usages of the memory controller corresponding to the plurality of memory access requests, store respective counts of the plurality of memory access requests having respective latencies corresponding to a plurality of latency ranges for the respective bandwidth usages, and configure operations of the memory controller in view of the respective counts for the respective bandwidth usages.

In one implementation, the memory controller may further include one or more registers configured to store the respective counts. Each of the one or more registers corresponds to a respective latency range of the plurality of latency ranges for the respective bandwidth usages. The respective latency ranges and the corresponding respective bandwidth usages are adjustable responsive to an input from a user device.

In one implementation, to configure the operations of the memory controller, the latency tracking logic is to adjust a scheduling order for execution of the plurality of memory access requests. In another implementation, to configure the operations of the memory controller, the latency tracking logic is to increase or decrease data transfer of a memory channel responsive to the memory channel having respective bandwidth usages above or below a threshold amount.

In one implementation, the processing device is further to determine the respective bandwidth usages for executing each of the plurality of memory access requests in the memory access queue over a specified time based on a number of memory access requests in the memory access queue.

In one implementation, the memory controller may also include one or more timers configured to determine the respective latencies for each of the plurality of memory access requests. The respective latencies may be based on a start time when a memory access request of the plurality of memory access requests enters the memory access queue and an end time when the memory access request leaves the memory system.

In one implementation, determining the respective bandwidth usages of the memory controller further includes comparing a number of memory access requests present in the memory access queue to a total number of memory access queue positions. In another implementation, determining the respective bandwidth usages of the memory controller further includes comparing a historical number of memory access requests executed by the memory controller over a specified time to a total number of memory access request execution slots for the specified time. In yet another implementation, determining the respective bandwidth usages of the memory controller further includes comparing a number of memory access requests present in the memory access queue and a historical number of memory access requests executed by the memory controller over a specified time to a total number of memory access queue positions and a total number of memory access request execution slots for the specified time.

In one implementation, the processing device is further to determine, based on each of the respective counts, a correlation between the respective latencies for the plurality of memory access requests and the respective bandwidth usages corresponding to the plurality of memory access requests. The processing device is further to determine a bandwidth usage of the respective bandwidth usages where an average latency of the respective latencies exceeds or fails to reach a threshold amount. Other technical features may be readily apparent to one skilled in the art from the following figures, descriptions, and claims.

In an aspect of the disclosure, a method of operation of a memory controller includes determining respective latencies for a plurality of memory access requests in a memory access queue, determining respective bandwidth usages of the memory controller corresponding to the plurality of memory access requests, storing respective counts of the plurality of memory access requests having respective latencies corresponding to a plurality of latency ranges for the respective bandwidth usages, and configuring operations of the memory controller in view of the respective counts for the respective bandwidth usages.

In an aspect of the disclosure, a system includes one or more memory devices. The system also includes a memory controller coupled to the one or more memory devices via one or more communication links. The system also includes a processing device coupled to the memory controller to execute latency tracking logic to determine respective latencies for a plurality of memory access requests in a memory access queue, determine respective bandwidth usages of the memory controller corresponding to the plurality of memory access requests, store respective counts of the plurality of memory access requests having respective latencies corresponding to a plurality of latency ranges for the respective bandwidth usages, and configure operations of the memory controller in view of the respective counts for the respective bandwidth usages.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a block diagram illustrating an example computing environment including a memory controller configured to track latency under load according to certain embodiments.

FIG. 2 is a block diagram illustrating an example of the memory controller including a memory access queue according to certain embodiments.

FIG. 3 is a block diagram illustrating an example set of one or more registers according to certain embodiments.

FIG. 4 is a flow diagram illustrating a method of tracking latency under load according to certain embodiments.

FIG. 5 is a block diagram illustrating a computer system according to certain embodiments.

### DETAILED DESCRIPTION OF EMBODIMENTS

The following description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

Embodiments described herein are related to latency under load tracking in a memory controller. Latency under load may refer to how long a given memory access transaction takes to be processed (i.e., latency) in relation to the bandwidth usage associated with the same memory access transaction (i.e., load).

Conventionally, there is no way to determine the latency under load of a memory controller using the memory controller itself (i.e., in-situ). Conventional solutions require a separate device to measure the bandwidth usage of the memory controller, but the separate device contributes to the overall bandwidth usage of the memory controller. This makes it challenging to know if the latency for memory access transactions is a result of the bandwidth usage experienced by the memory controller itself or a byproduct of the separate device being used to measure the bandwidth usage.

Similarly, conventional solutions that utilize the processor of the host system to determine bandwidth usage inevitably mix the bandwidth usage of the processor itself with that of the memory controller and the associated memory system (i.e., DRAM devices). This makes it challenging to know if the latency experienced by a given memory access transaction is related to the memory controller and the DRAM devices, or from the processor of the host system, or both. This makes it difficult to determine where computing performance is lost or where areas of improved processing are available when higher latencies are experienced. This may also lead to inefficiencies in scheduling the various memory access transactions, as the memory controller does not have the information needed to effectively allocate data resources to a memory channel that is experiencing greater latency and/or higher bandwidth usage than expected.

The devices, systems, and methods disclosed herein provide latency under load tracking in a memory controller. In some embodiments, a memory controller includes a processing device to execute latency tracking logic to determine respective latencies for a plurality of memory access requests in a memory access queue. The latency tracking logic further determines respective bandwidth usages of the memory controller corresponding to the plurality of memory access requests and stores respective counts of the plurality of memory access requests having respective latencies corresponding to a plurality of latency ranges for the respective bandwidth usages. The latency tracking logic can further configure operations of the memory controller in view of the respective counts for the respective bandwidth usages, as will be described in more detail below.

The systems, devices, and methods disclosed herein have advantages over conventional solutions. By implementing logic within the memory controller to determine the memory controller's bandwidth usage, the memory controller can proactively update its own scheduling policy to better manage memory access requests and reduce the bandwidth usage of the memory access requests when the latency exceeds a threshold amount. In some embodiments, the threshold amount may be a bandwidth usage that corresponds to a significant increase in latency that was not present at lower bandwidth usages.

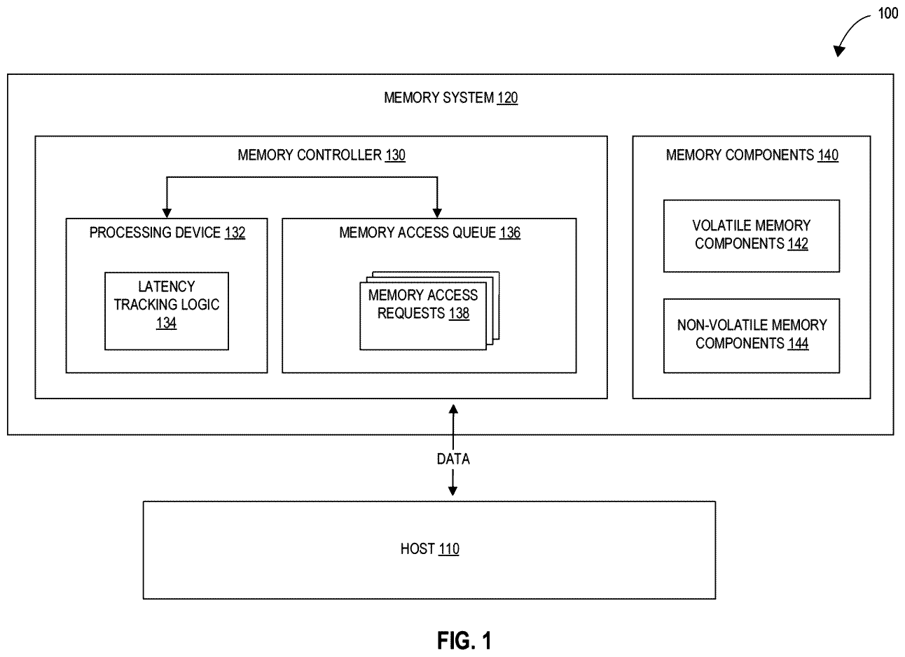

FIG. 1 is a block diagram illustrating an example computing environment 100 including a memory controller 130 configured to track latency under load according to certain embodiments. The memory controller 130 may facilitate the transfer of data between a host 110 and a memory system 120 having various memory components 140. These memory components 140 may be implemented using various media types and may include, for example, volatile memory components 142, non-volatile memory components 144, or a combination of such. The memory system 120 may represent a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, or a hard disk drive (HDD). Examples of memory modules include a dual in-line memory module (DIMM), a small outline DIMM (SO-DIMM), and a non-volatile dual in-line memory module (NVDIMM).

The computing environment 100 may further include the host 110 that is coupled to the memory controller 130. The host 110 may use the memory controller 130, for example, to write data to and read data from the various memory components 140 of the memory system 120. As used herein, “coupled to” generally refers to a connection between components, which may be an indirect communicative connection or direct communicative connection (i.e., without intervening components), whether wired or wireless, including connections such as electrical, optical, magnetic, etc. The host 110 may be a computing device such as a desktop computer, laptop computer, network server, mobile device, embedded computer (e.g., one included in a vehicle, industrial equipment, or a networked commercial device), or such computing device that includes a memory and a processing device. The host 110 may include or be coupled to the memory controller 130 so that the host 110 may read data from or write data to the memory system 120. In some embodiments, the host 110 is coupled to the memory controller 130 via a physical host interface. Examples of a physical host interface include, but are not limited to, a serial advanced technology attachment (SATA) interface, a peripheral component interconnect express (PCIe) interface, a compute express link (CXL) interface, universal serial bus (USB) interface, Fibre Channel, Serial Attached SCSI (SAS), etc. The physical host interface may be used to transmit data between the host 110 and the memory system 120. The host 110 may further utilize an NVM Express (NVMe) interface to access the memory components 140 when the memory system 120 is coupled with the host 110 by the PCIe interface. The physical host interface may provide an interface for passing control, address, data, and other signals between the memory system 120 and the host 110.

In some embodiments, the memory system 120 includes and is coupled to the memory controller 130. The memory controller 130 may communicate with the memory components 140 of the memory system 120 to perform memory access transactions such as reading data, writing data, or erasing data at the memory components 140 and other such memory access transactions. The memory controller 130 may include hardware such as one or more integrated circuits and/or discrete components, a buffer memory, or a combination thereof. The memory controller 130 may be a microcontroller, special purpose logic circuitry (e.g., a field programmable gate array (FPGA), an application specific integrated circuit (ASIC), etc.), or other suitable processor.

In some embodiments, the memory controller 130 receives commands from the host 110 and converts the commands into instructions or appropriate commands to achieve the desired access to the memory components 140. The memory controller 130 may be responsible for other operations such as wear leveling operations, garbage collection operations, error detection and error-correcting code (ECC) operations, encryption operations, caching operations, and address translations between a logical block address and a physical block address that are associated with the memory components 140. The memory controller 130 may further include host interface circuitry to communicate with the host 110 via the physical host interface. The host interface circuitry may convert the commands received from the host 110 into command instructions to access the memory components 140 as well as convert responses associated with the memory components 140 into information for the host 110.

The memory controller 130 may include a processing device 132 (i.e., processor) configured to execute instructions stored in a local memory. For example, the local memory of the memory controller 130 may include an embedded memory configured to store instructions for performing various processes, operations, logic flows, and methods that control operation of the memory system 120, including handling communications between the memory system 120 and the host 110. In some embodiments, the local memory may include memory registers storing memory pointers, fetched data, counters, etc. The local memory may also include read-only memory (ROM) for storing micro-code. The processing device 132 may further be configured to execute latency tracking logic 134 to determine both the latency for a memory access request and the bandwidth usage associated with the same memory access request. The latency tracking logic 134 may further increase a count of one or more registers associated with the latency and the bandwidth usage of the memory access request.

In some embodiments, the memory controller 130 may include a memory access queue 136 configured to store one or more memory access requests 138. The memory access requests 138 may be commands to perform memory access transactions such as reading data, writing data, or erasing data at the memory components 140 of the memory system 120. The memory controller 130 may determine an order for processing each of the commands based on a size, age (i.e., how long each of the memory access requests 138 have been waiting in the memory access queue 136), and/or an urgency of the requested operation.

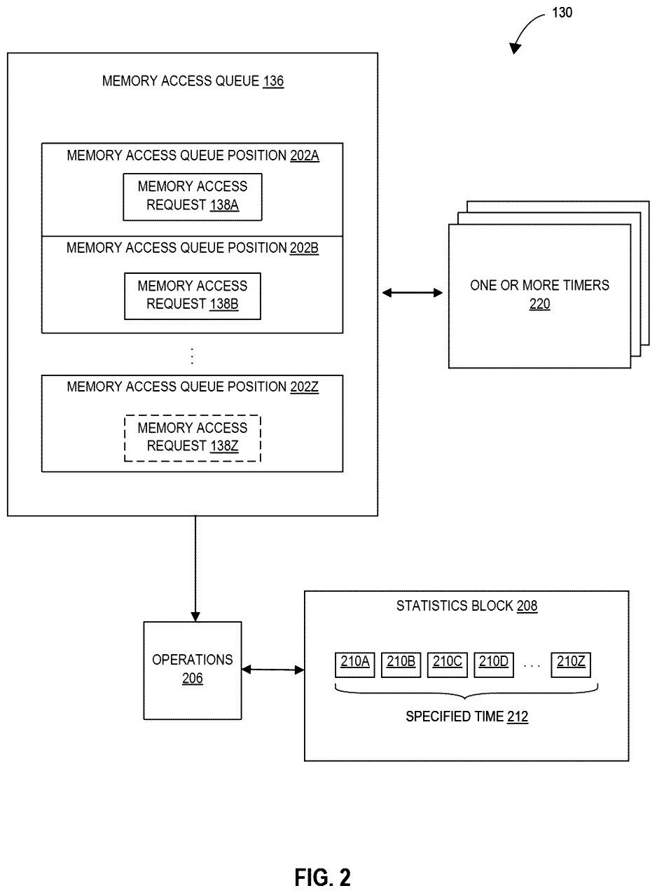

FIG. 2 is a block diagram illustrating an example of the memory controller 130 including a memory access queue 136 according to certain embodiments. The memory controller 130 may perform various operations 206 based on the amount and/or type of memory access requests stored in the memory access queue 136. The operations 206 may be further informed by the history of previous memory access requests stored in a statistics block 208.

The memory access queue 136 may include one or more memory access queue positions 202A-Z. Each of the memory access queue positions 202A-Z may store a single memory access request 138A-Z at a time. The memory access requests 138A-Z may enter the memory access queue 136 based on the order in which they were received from a host (i.e., the host 110 of FIG. 1). In some embodiments, the memory access queue 136 may be separated further into a read queue (i.e., to store memory access requests 138A-Z associated with a request to read data), a separate write queue (i.e., to store memory access requests 138A-Z associated with a request to write data), and potentially other such queues.

In some embodiments, the total amount of memory access requests 138A-Z that are present in the memory access queue 136 represents a memory access queue depth. In some embodiments, the memory controller 130 may process requests to read data in the read queue of the memory access queue 136 in the order they are received. In some embodiments, the memory controller 130 may prioritize a newer request to read data (i.e., a request that entered the read queue more recently) over an older request to read data (i.e., a request that entered the read queue less recently) if the newer request to read data is marked as urgent by the host 110 or is otherwise given a higher priority. In some embodiments, the memory controller 130 may temporarily stop processing requests to read data in order to process a number of requests to write data in the write queue of the memory access queue 136. The write queue may fill each of the memory access queue positions 202A-Z until the write queue is full (i.e., the high-water mark of the write queue) and then proceed to process all of the requests to write data before resuming processing of the requests to read data.

The processing device (i.e., the processing device 132 of FIG. 1) of the memory controller 130 may execute processing logic (i.e., the latency tracking logic 134) to configure operations 206 responsive to the amount of memory access requests 138A-Z in the memory access queue 136 (i.e., the queue depth). For example, the operations 206 may include a scheduling order operation, and the latency tracking logic 134 may adjust the scheduling order in which the memory access requests 138A-Z are processed. As another example, the operations 206 may include a data transfer operation, and the latency tracking logic 134 may increase or decrease data transfer of a memory channel responsive to the memory channel having a bandwidth usage above or below a threshold amount. The threshold amount may vary based on the amount of memory channels present in the memory system and may correspond to a significant increase in latency for a given bandwidth usage that was not present at lower bandwidth usages. As an example for illustration purposes only, if a first memory access request 138A is a read operation and has a latency of 100 nanoseconds (ns) at a bandwidth usage of 60 gigabytes per second (GB/s), a second memory access request 138B is a read operation and has a latency of 105 ns at a bandwidth usage of 80 GB/s, and a third memory access request 138Z is a read operation and has a latency of 500 ns at a bandwidth usage of 100 GB/s, the threshold amount may be about 80 GB/s to about 100 GB/s. In other words, when a memory access channel begins to experience bandwidth usages of about 80 GB/s to about 100 GB/s, the memory controller 130 may reduce the amount of data transfer bandwidth (i.e., the amount of bandwidth used by the memory access requests 138A-Z) of the impacted memory channel by reducing the number of memory access requests 138A-Z permitted in the memory access queue 136 to prevent a sudden and significant increase in latency.

In some embodiments, the memory controller 130 may increase the amount of data transfer bandwidth of a memory access channel that is being underutilized. The memory controller 130 may identify an underutilized memory access channel by comparing the bandwidth usage of the underutilized memory access channel to a threshold amount. The threshold amount may correspond to an upper limit of bandwidth usage having a stable latency range. As an example for illustration purposes only, if a first memory access request 138A is a read operation and has a latency of 100 ns at a bandwidth usage of 60 GB/s, a second memory access request 138B is a read operation and has a latency of 105 ns at a bandwidth usage of 80 GB/s, and a third memory access request 138Z is a read operation and has a latency of 500 ns at a bandwidth usage of 100 GB/s, the threshold amount may be between about 60 GB/s to about 80 GB/s. In other words, when a memory access channel experiences bandwidth usages of less than about 80 GB/s, the memory controller 130 may increase the amount of data transfer bandwidth of the underutilized memory access channel by increasing the memory access queue depth (i.e., increasing the number of memory access queue positions 202A-Z to increase a total amount of memory access requests 138A-Z in the memory access queue 136). This may allow the underutilized memory access channel to perform at a higher bandwidth usage with little or no impact to the respective latencies.

Both the latency and the bandwidth usage of a given memory access request 138A-Z may be determined by the latency tracking logic 134. The latency may be based on the difference between a start time and an end time of a memory access request 138A-Z. The start time may be based on when the memory access request 138A-Z enters the memory access queue 136 (i.e., the memory controller 130 receives a memory access request from the host 110), and the end time may be based on when the memory access request 138A-Z exits the memory system 120 (i.e., the memory controller 130 processes the memory access request by sending the requested data back to the host 110 and/or writing the requested data to storage medium of the memory system). The start time and/or the end time may be determined by one or more timers 220 in the memory controller 130.

The bandwidth usage of a given memory access request 138A-Z may be determined in a variety of ways. In a first method of some embodiments, the bandwidth usage is determined by comparing the number of memory access requests 138A-Z present in the memory access queue 136 with the total number of memory access queue positions 202A-Z. For example, if the memory access queue 136 has a total of ten memory access queue positions 202A-Z, and five of those memory access queue positions 202A-Z have a memory access request 138-Z, the bandwidth usage may be 50% (i.e., 5/10=50%). As another example, if the memory access queue 136 has a total of ten memory access queue positions 202A-Z, and three of those memory access queue positions 202A-Z have a memory access request 138-Z, the bandwidth usage may be 30% (i.e., 3/10=30%).

In a second method of some embodiments, the bandwidth usage is determined by comparing a historical number of memory access requests executed by the memory controller 130 over a specified time 212 to a total number of memory access request execution slots 210A-Z over the specified time 212. For example, if a statistics block 208 of the memory controller 130 records three memory access requests previously executed by the memory controller 130 and the statistics block 208 has six memory access request execution slots, the bandwidth usage may be 50% (i.e., 3/6=50%). The specified time 212 may be a pre-set time interval and/or may be programmed responsive to a user input.

In a third method of some embodiments, the bandwidth usage is determined by combining the first method and the second method for determining the bandwidth usage of a given memory access request. That is, the bandwidth usage may be determined by comparing the number of memory access requests 138A-Z present in the memory access queue 136 and the historical number of memory access requests executed by the memory controller 130 over a specified time 212 to the total number of memory access queue positions 202A-Z and the total number of memory access request execution slots 210A-Z over the specified time 212. For example, if there are five memory access requests 138A-Z present in the memory access queue 136, three memory access requests previously executed by the memory controller 130 over the 212, the memory access queue 136 has a total of ten memory access queue positions 202A-Z, and the statistics block 208 has six memory access request execution slots for the specified time 212, the bandwidth usage would be 50% (i.e., (5+3)/(10+6)=50%).

In some embodiments, where the memory access queue 136 is separated into a read queue and a write queue, the memory access requests 138A-Z in the write queue may be omitted from the previously described calculation methods. Because these memory access requests 138A-Z in the write queue may not be processed by the memory controller 130 until the high-water mark of the write queue is reached, they may not be processed in the same order as memory access requests 138A-Z in the read queue, and therefore may have a lesser impact on bandwidth usage.

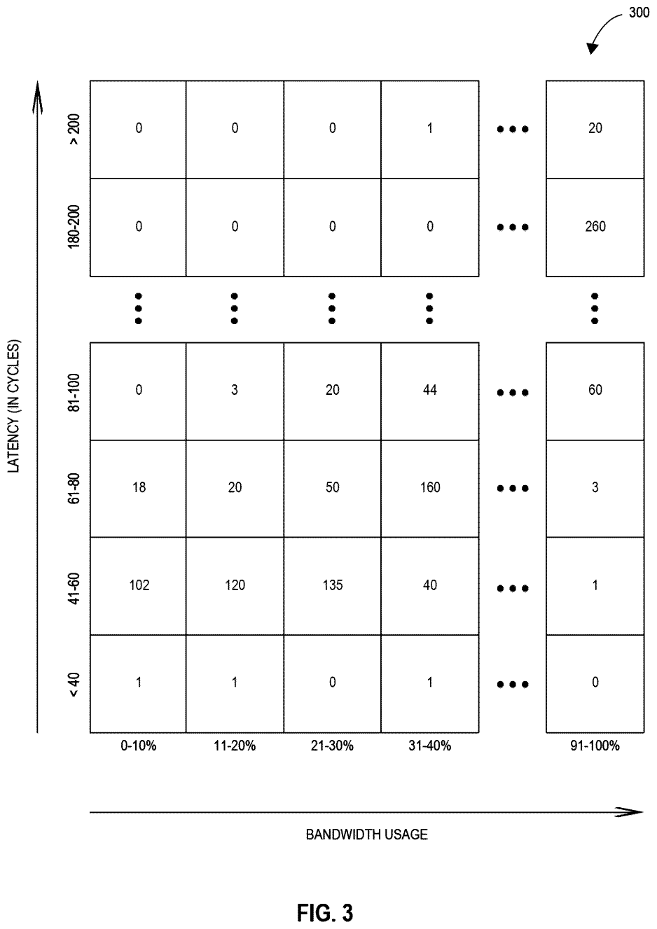

FIG. 3 is a block diagram illustrating an example set of one or more registers according to certain embodiments. In some embodiments, the memory controller (i.e., the memory controller 130 of FIG. 1) has an array of counters in on-chip storage for each memory channel (i.e., in static random-access memory (SRAM)). When the memory controller 130 receives a memory access request, a processing device (i.e., the processing device 132 of FIG. 1) executing latency tracking logic (i.e., the latency tracking logic 134 of FIG. 1) may determine a latency and a bandwidth usage for the memory access request and increment a count of a corresponding register. For example, if the latency tracking logic 134 determines a memory access request has a latency of 20 cycles (i.e., a cycle of a specified time) and a bandwidth usage of 5%, the latency tracking logic 134 would increment the count of the register represented by the bottom left box corresponding to a latency of less than 40 cycles and a bandwidth usage of between 0% and 10%. As another example, if the latency tracking logic 134 determines a memory access request has a latency of 300 cycles and a bandwidth usage of 95%, the latency tracking logic 134 would increment the count of the register represented by the top right box corresponding to a latency of more than 200 cycles and a bandwidth usage of between 91% and 100%. By incrementing the respective counts of each register, the memory controller 130 may determine when a given memory access request has exceeded or failed to reach a threshold amount and configure its operations to redirect processing power to the affected memory channel and/or update its scheduling order to process the memory access requests with the least amount of latency.

In some embodiments, the respective counts of the registers may be interpreted as a histogram and/or be used to construct a latency under load curve. These types of graphical representations may be provided to an end user device in order to understand the overall performance of the memory controller 130 and/or the host 110.

In some embodiments, the latency and bandwidth usage of memory access requests (i.e., the memory access requests 138 of FIG. 1) may be tracked for a discrete amount of time (i.e., from a tracking start time to a tracking end time). The tracking start time may be initialized by writing a value (i.e., incrementing the count of the one or more registers) to the one or more registers. Prior to writing a first value to the one or more registers, each of the one or more registers may have a count of zero. When the first value is written to the one or more registers, the tracking start time may be stored in on-chip storage (i.e., in SRAM). When a final value is written to a predetermined register, the tracking end time may be stored in the on-chip storage and a processing device of the memory controller 130 may determine a difference between the tracking start time and the tracking end time. This difference may be provided to an end user device along with the respective counts of the registers along and/or the graphical representation in order to understand the overall performance of the memory controller 130 and/or the host 110. In some embodiments, storing the tracking end time may cause the array of counters to be initialized to a value of zero. In some embodiments, storing the tracking end time may not cause the array of counters to be initialized to a value of zero, but rather allow the counters to continue increasing for a new tracking period. The method for starting tracking (i.e., initializing the tracking start time), stopping tracking (i.e., storing the tracking end time), resetting counters (i.e., setting each counter back to a value of zero), and transferring counters back to the end user device may be through Mode Register Writes (i.e., the process of writing configuration or control settings to a mode register such as a memory module) to different registers or portions of shared registers, or through dedicated commands specific to each of these tasks.

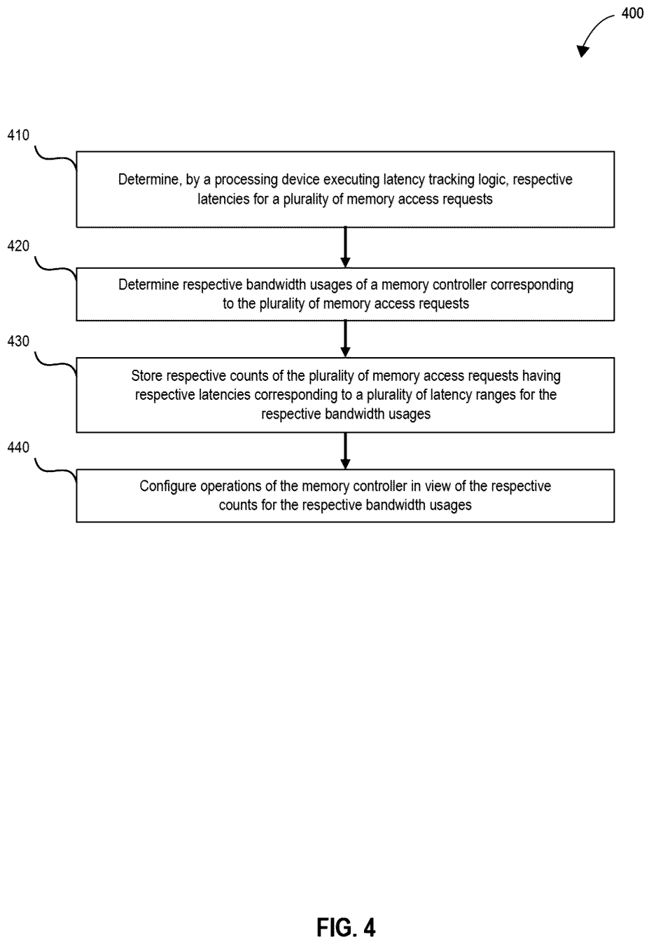

FIG. 4 is a flow diagram illustrating a method 400 of tracking latency under load according to certain embodiments. In some embodiments, the method 400 is performed by processing logic that includes hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, a non-transitory machine-readable storage medium stores instructions that when executed by a processing device, cause the processing device to perform the method 400.

For simplicity of explanation, the method 400 is depicted and described as a series of operations. However, operations in accordance with this disclosure can occur in various orders and/or concurrently and with other operations not presented and described herein. Furthermore, in some embodiments, not all illustrated operations are performed to implement the method 400 in accordance with the disclosed subject matter. In addition, those skilled in the art will understand and appreciate that the method 400 could alternatively be represented as a series of interrelated states via a state diagram or events.

Referring to FIG. 4, at block 410, a processing device executing latency tracking logic may determine respective latencies for a plurality of memory access requests in a memory access queue. In some embodiments, the latency may be based on the difference between a start time and an end time of a memory access request (i.e., the memory access requests 138A-Z of FIG. 2). The start time may be based on when the memory access request enters the memory access queue (i.e., the memory access queue 136 of FIG. 1), and the end time may be based on when the memory access request exits the memory access queue. The start time and/or the end time may be determined by one or more timers 220 in the memory controller.

At block 420, the processing device executing latency tracking logic may determine respective bandwidth usages of a memory controller corresponding to the plurality of memory access requests. The bandwidth usage of a given memory access request may be determined in a variety of ways. In a first method of some embodiments, the bandwidth usage is determined by comparing the number of memory access requests present in the memory access queue with a total number of memory access queue positions (i.e., the memory access queue positions 202A-Z of FIG. 2). In a second method of some embodiments, the bandwidth usage is determined by comparing a historical number of memory access requests executed by the memory controller over a specified time to a total number of memory access request execution slots (e.g., the memory access request execution slots 210A-Z of FIG. 2) over the specified time. In a third method of some embodiments, the bandwidth usage is determined by combining the first method and the second method for determining the bandwidth usage of a given memory access request. That is, the bandwidth usage may be determined by comparing the number of memory access requests present in the memory access queue and the historical number of memory access requests executed by the memory controller over a specified time to the total number of memory access queue positions and the total number of memory access request execution slots over the specified time.

At block 430, the processing device executing latency tracking logic may store respective counts of the plurality of memory access requests having respective latencies corresponding to a plurality of latency ranges for the respective bandwidth usages. In some embodiments, the memory controller has an array of counters in on-chip storage for each memory channel (i.e., in SRAM). When the memory controller receives a memory access request, the processing device executing latency tracking logic may determine a latency and a bandwidth usage for the memory access request (i.e., as described in blocks 410 and 420) and increment a count of a corresponding register.

At block 440, the processing device executing latency tracking logic may configure operations of the memory controller in view of the respective counts for the respective bandwidth usages. By incrementing the respective counts of each register described in block 430, the memory controller may determine when a given memory access request has exceeded or failed to reach a threshold amount and configure its operations to redirect processing power to the affected memory channel and/or update its scheduling order to process the memory access requests with the least amount of latency.

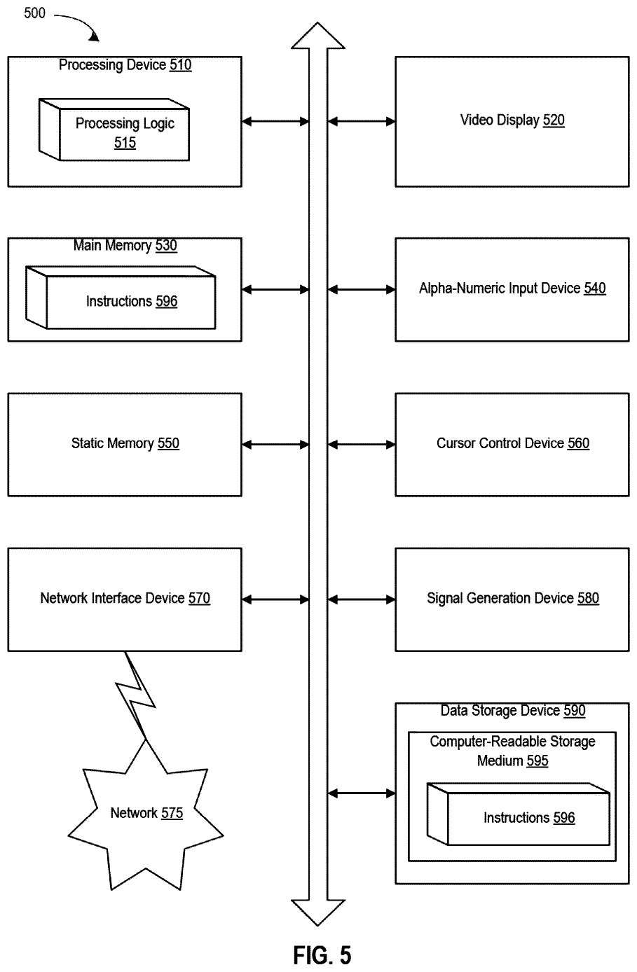

FIG. 5 is a block diagram illustrating a computer system according to certain embodiments. In some embodiments, the computer system 500 is connected (e.g., via a network, such as a Local Area Network (LAN), an intranet, an extranet, or the Internet) to other computer systems. In some embodiments, the computer system 500 operates in the capacity of a server or a client computer in a client-server environment, or as a peer computer in a peer-to-peer or distributed network environment. In some embodiments, the computer system 500 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 includes a processing device 510, a main memory 530 (e.g., read-only memory (ROM), flash memory, dynamic random access memory (DRAM) such as synchronous DRAM (SDRAM) or Rambus DRAM (RDRAM)), a static memory 550 (e.g., flash memory, static random access memory (SRAM), etc.), and a data storage device 590, which communicate with each other via a bus.

In some embodiments, the processing device 510 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, the computer system 500 further includes a network interface device 570 (i.e., coupled to a network 575). In some embodiments, the computer system 500 also includes a video display 520 (e.g., an LCD), an alpha-numeric input device 540 (e.g., a keyboard), a cursor control device 560 (e.g., a mouse), and a signal generation device 580.

In some implementations, the data storage device 590 includes a non-transitory computer-readable storage medium 595 on which store instructions 596 encoding any one or more of the methods or functions described herein, including instructions for implementing methods described herein.

In some embodiments, the instructions 596 also reside, completely or partially, within the main memory 530 and/or within the processing device 510 during execution thereof by the computer system 500, hence, in some embodiments, the main memory 530 and the processing device 510 also constitute machine-readable storage media.

While the computer-readable storage medium 595 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In some embodiments, the methods, components, and features described herein are implemented by discrete hardware components or are integrated in the functionality of other hardware components such as ASICS, FPGAs, DSPs or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “identifying,” “receiving,” “causing,” “training,” “generating,” “providing,” “obtaining,” “interrupting,” “determining,” “transmitting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or includes a general purpose computer system selectively programmed by a computer program stored in the computer system. Such a computer program is stored in a computer-readable tangible storage medium.

Some of the methods and illustrative examples described herein are not inherently related to any particular computer or other apparatus. In some embodiments, various general purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A memory controller comprising:
a processing device to execute latency tracking logic to:
determine respective latencies for a plurality of memory access requests in a memory access queue;
determine respective bandwidth usages of the memory controller corresponding to the plurality of memory access requests;
store respective counts of the plurality of memory access requests having respective latencies corresponding to a plurality of latency ranges for the respective bandwidth usages; and
configure operations of the memory controller in view of the respective counts for the respective bandwidth usages.

2. The memory controller of claim 1 further comprising one or more registers configured to store the respective counts, wherein each of the one or more registers corresponds to respective latency ranges of the plurality of latency ranges for the respective bandwidth usages, and wherein the respective latency ranges and the corresponding respective bandwidth usages are adjustable responsive to an input from a user device.

3. The memory controller of claim 1, wherein to configure the operations, the latency tracking logic is to adjust a scheduling order of the plurality of memory access requests.

4. The memory controller of claim 1, wherein to configure the operations, the latency tracking logic is to increase or decrease data transfer of a memory channel responsive to the memory channel having respective bandwidth usages above or below a threshold amount.

5. The memory controller of claim 1, wherein the processing device is further to:
determine the respective bandwidth usages for executing each of the plurality of memory access requests in the memory access queue over a specified time based on a number of memory access requests in the memory access queue.

6. The memory controller of claim 1 further comprising one or more timers configured to determine the respective latencies for each of the plurality of memory access requests, wherein the respective latencies are based on a start time when a memory access request of the plurality of memory access requests enters the memory access queue and an end time when the memory access request leaves the memory system.

7. The memory controller of claim 1, wherein determining the respective bandwidth usages of the memory controller further comprises:
comparing a number of memory access requests present in the memory access queue to a total number of memory access queue positions.

8. The memory controller of claim 1, wherein determining the respective bandwidth usages of the memory controller further comprises:
comparing a historical number of memory access requests executed by the memory controller over a specified time to a total number of memory access request execution slots for the specified time.

9. The memory controller of claim 1, wherein determining the respective bandwidth usages of the memory controller further comprises:
comparing a number of memory access requests present in the memory access queue and a historical number of memory access requests executed by the memory controller over a specified time to a total number of memory access queue positions and a total number of memory access request execution slots for the specified time.

10. The memory controller of claim 1, wherein the processing device is further to:
determine, based on each of the respective counts, a correlation between the respective latencies for the plurality of memory access requests and the respective bandwidth usages corresponding to the plurality of memory access requests; and
determine a bandwidth usage of the respective bandwidth usages where an average latency of the respective latencies exceeds or fails to reach a threshold amount.

11. A method of operation of a memory controller, the method comprising:
determining, by a processing device executing latency tracking logic, respective latencies for a plurality of memory access requests in a memory access queue;
determining respective bandwidth usages of the memory controller corresponding to the plurality of memory access requests;
storing respective counts of the plurality of memory access requests having respective latencies corresponding to a plurality of latency ranges for the respective bandwidth usages; and
configuring operations of the memory controller in view of the respective counts for the respective bandwidth usages.

12. The method of claim 11 further comprising:
receiving, from one or more timers, a start time corresponding to when a memory access request of the plurality of memory access requests enters the memory access queue;
receiving, from the one or more timers, an end time corresponding to when the memory access request leaves the memory system; and
determining the respective latencies for each of the plurality of memory access requests based on a difference between the start time and the end time.

13. The method of claim 11, wherein determining the respective bandwidth usages of the memory controller further comprises:
comparing a number of memory access requests present in the memory access queue to a total number of memory access queue positions.

14. The method of claim 11, wherein determining the respective bandwidth usages of the memory controller further comprises:
comparing a historical number of memory access requests executed by the memory controller over a specified time to a total number of memory access request execution slots for the specified time.

15. The method of claim 11, wherein determining the respective bandwidth usages of the memory controller further comprises:
comparing a number of memory access requests present in the memory access queue and a historical number of memory access requests executed by the memory controller over a specified time to a total number of memory access queue positions and a total number of memory access request execution slots for the specified time.

16. A system comprising:
one or more memory devices;
a memory controller coupled to the one or more memory devices via one or more communication links; and
a processing device coupled to the memory controller to execute latency tracking logic to:
determine respective latencies for a plurality of memory access requests in a memory access queue;
determine respective bandwidth usages of the memory controller corresponding to the plurality of memory access requests;
store respective counts of the plurality of memory access requests having respective latencies corresponding to a plurality of latency ranges for the respective bandwidth usages; and
configure operations of the memory controller in view of the respective counts for the respective bandwidth usages.

17. The system of claim 16, wherein the memory channel further comprises one or more timers configured to determine the respective latencies for each of the plurality of memory access requests, wherein the respective latencies are based on a start time when a memory access request of the plurality of memory access requests enters the memory access queue and an end time when the memory access request leaves the memory system.

18. The system of claim 16, wherein determining the respective bandwidth usages of the memory controller further comprises:
comparing a number of memory access requests present in the memory access queue to a total number of memory access queue positions.

19. The system of claim 16, wherein determining the respective bandwidth usages of the memory controller further comprises:
comparing a historical number of memory access requests executed by the memory controller over a specified time to a total number of memory access request execution slots for the specified time.

20. The system of claim 16, wherein determining the respective bandwidth usages of the memory controller further comprises:
comparing a number of memory access requests present in the memory access queue and a historical number of memory access requests executed by the memory controller over a specified time to a total number of memory access queue positions and a total number of memory access request execution slots for the specified time.
